(19) United States
(12) Patent Application Publication
(10) Pub. No.: US 2007/0101487 A1
(43) Pub. Date: May 10, 2007

(54) Secure and hygienic shower/commode chair seat/cover and commode incorporating the same

(76) Inventor: Suzy Major, Oregon City, OR (US)

Correspondence Address: ATER WYNNE LLP, 222 SW COLUMBIA, SUITE 1800, PORTLAND, OR, 97201-6618, US

(21) Appl. No.: 11/593,680

(22) Filed: Nov. 6, 2006

Related U.S. Application Data
(60) Provisional application No. 60/734,550, filed on Nov. 7, 2005.

(51) Int. Cl. A61G 7/02; A47K 11/06

(52) U.S. Cl. 4/480

(57) ABSTRACT

A seat for use with a shower or commode chair includes a seat region including a contoured upper surface for supporting a user's buttocks and thighs, the upper surface including dual laterally spaced recesses in the upper surface to accommodate the user's thighs; and a lumbar support region behind the seat region for supporting the user's lower back. The seat region and the lumbar support region are integrally molded together into a unitary seat. The unitary seat is formed by injection or blow molding formed, for example, of foam having defined temporary deflection and indefinite shape retention characteristics. At least a front surface of the lumbar support region and at least the upper surface of the seat region are substantially covered with a substantially impervious material that is non-reactive with the user's skin.

### RELATED APPLICATIONS

The present application claims priority to U.S. Provisional Patent Application Ser. No. 60/734,550, entitled SECURE AND HYGIENIC SHOWER/COMMODE CHAIR SEAT/COVER and filed 7 Nov. 2005, the disclosure of which is incorporated herein in its entirety by this reference.

### BACKGROUND OF THE INVENTION

This invention relates generally to the field of commode or shower chairs used by disabled persons who lack full use of or mobility in their limbs. More particularly, it concerns a seat or seat cover for such a commode or shower chair that provides increased durability, security, comfort and hygiene.

Conventional commode or shower chair seats are substantially planar, relatively thin and hard square or rectangular expanses, sometimes padded with slab foam and covered with vinyl, the expanses having oval or round openings in their centers. They provide durable support for the weight of a user sitting thereon. They generally mount on a chair that provides side-arm and back supports. Their central openings typically are located above a removable toilet bowl or bedpan of some sort for disposing of waste, e.g. feces or urine. In a commode setting, the chairs are used for elimination by males and females who lack full use of or mobility in their limbs. Often, such disabled persons require manual assistance, e.g. lift and guidance, on and off the seat. In a shower setting, the chairs are typically used for seated support of disabled persons while they shower or sponge bathe. Such chairs are often equipped with wheels so they can be easily rolled into and out of the shower area of a bathroom when needed for bathing or so they can be easily rolled to a bedside or living area of living quarters when needed for elimination.

### SUMMARY OF THE INVENTION

A seat for use with a shower or commode chair includes a seat region including a contoured upper surface for supporting a user's buttocks and thighs, the upper surface including dual laterally spaced recesses in the upper surface to accommodate the user's thighs; and a lumbar support region behind the seat region for supporting the user's lower back. The seat region and the lumbar support region are integrally molded together into a unitary seat. The unitary seat is formed by injection or blow molding formed, for example, of foam having defined temporary deflection and indefinite shape retention characteristics. At least a front surface of the lumbar support region and at least the upper surface of the seat region are substantially covered with a substantially impervious material that is non-reactive with the user's skin.

### BRIEF DESCRIPTION OF THE DRAWINGS

FIG. 1 is an isometric view of the invented seat/cover, made in accordance with a first embodiment in which the opening is oval and generally central to the seat for use by males, with a conventional commode/shower chair.

FIG. 2 is a front elevation of the invented seat/cover made in accordance with one embodiment of the invention.

FIG. 3 is a top view corresponding to FIG. 2.

FIG. 4 is a left-side elevation corresponding to FIG. 2.

FIG. 5 is a rear elevation corresponding to FIG. 2.

FIG. 6 is a bottom view corresponding to FIG. 2.

FIG. 7 is an isometric view of the invention corresponding to FIG. 1 but in an alternative embodiment in which a stepped portion of the through opening extends to the front edge of the seat for use by females.

FIG. 8 is a top view of the invention corresponding to FIG. 3, but in an alternative embodiment in which the through opening is omitted for use of the invented seat/cover with a shower seat instead of a commode.

### DETAILED DESCRIPTION OF THE PREFERRED EMBODIMENTS

The invented commode or shower seat/cover may be seen to be either a seat or a seat cover. In other words, it can be supported by a custom or stock chair frame lacking an integral seat, thereby acting as a seat itself, or it can be supported by, thus to cover, a conventional stock commode/shower chair. Novel features of the invented seat over prior art seats include soft durability for greater comfort, a hygienic soft outer layer that is easily sterilized, a lumbar support for the user's lower back and a contoured upper surface for comfortable, secure, conforming support of the user's buttocks and thighs.

The invented seat preferably is integrally molded in one piece. An upper surface preferably takes the form of a pliant but durable support that is contoured for conforming, secure, comfortable fit with the user's lower back, buttocks and thighs. The one-piece molded seat/cover has been discovered to provide excellent structural support, comfort, security, hygiene and fit. Alternatively, and also within the spirit and scope of the invention, the one-piece molded seat/cover can include molded thereinto an armature, e.g. a wire-frame or aluminum or otherwise lightweight but durable support member to strengthen a less durable, e.g. a lower density, molded foam.

In accordance with one embodiment of the invention the seat/cover is made of molded polyurethane foam exhibiting so-called “memory”, i.e. visco-elasticity. Preferably it is made of a medium grade of such molded foam, although within the spirit and scope of the invention a denser or lighter foam can be used, as are available, for example, from www.BrynHill.com. In accordance with one embodiment of the invention, a water-blown, poured or injection-molded polyurethane foam is used to produce smooth contours without glue or fabrication lines or seams, an in which the density of the foam is sufficiently high to provide seated support and comfort while dispersing body heart efficiently.

Also in accordance with one embodiment of the invention the invented seat/cover is covered with a seamless hygienic envelope preferably made of an anti-microbial, breathe-able but waterproof fabric and preferably welded or otherwise suitably affixed around the assembled seat. (Those of skill in the art will appreciate that the envelope is not explicitly illustrated since it effectively is a form-fitting cover that invisibly hugs the outer surface of the seat/cover.) The advantage of this cover is that the fabric from which it is made is non-permeable to body fluids and, when welded to the outer surface of the molded foam, the invented seat/cover is waterproof and durable, i.e. the cover protects the molded foam from fluid invasion and deterioration over time.

An FDA-approved version of such fabric is 5 mils thick and is available as Dartex P417 at www.Dartexcoatings.com. It is advertised as being waterproof in excess of BS 5455 and water penetration resistant to 50 kiloPascals (kPa). It is advertised as providing a biostatic (anti-mycotic) coating that is impenetrable by virus and bacteria. It can be welded using radio frequency (RF) or ultrasonic techniques to produce water- and air-impermeable seams, rendering the coating virtually seamless. It is advertised as meeting applicable fire standards. It is advertised as being “Oekotex” certified and tested for ISO 10993 bio-compatibility compliance. Finally, it is advertised as withstanding flexure, stretching, aging and abrasion over a long life. Such a coating is available from www.cascosolutions.com. Thus its combination of pressure sore relief, infection control and unrivaled patient comfort make it a preferred coating in accordance with the invention.

Those of skill in the art will appreciate, however, that alternative envelopes including no envelope at all are contemplated as being within the spirit and scope of the invention. It is also possible that the so-called “miracle” foam described above might be chemically treated or structured so as to present an outer surface to the user that meets any particular hygiene requirements, thus obviating such a separate coating or envelope provision.

For example, in accordance with one embodiment of the invention, a latex paint-based spray coating alternatively is used to seal the outer surface of the memory foam thereby to render it substantially fluid-impervious and to render it hygienic. Those of skill in the art will appreciate that latex paint is adherent, durable and fluid impervious, while being flexible without cracking or peeling when the memory foam substrate to which it adheres flexes under use. For aesthetics, the outer surface of the invented seat/cover can be colored or patterned, as desired, compatible with a sleeve, envelope or other covering and compatible also with a spray coating.

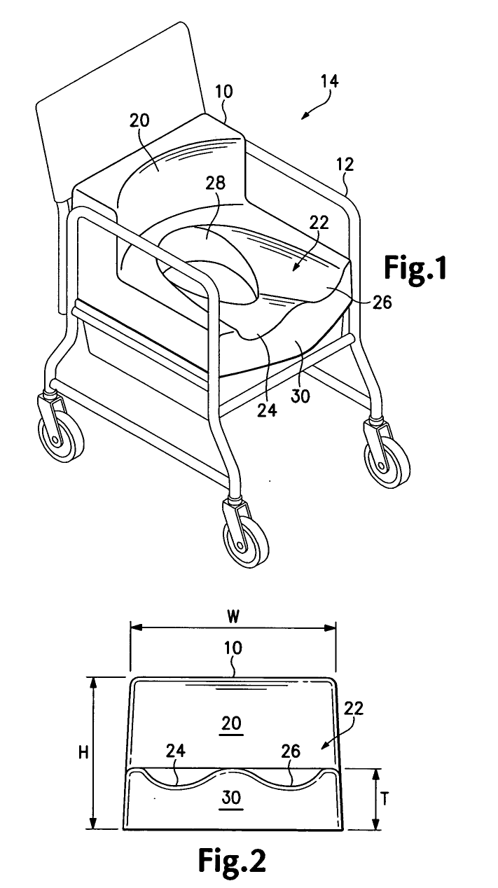

To accommodate male and female users' preferences, the invented seat is provided in two nearly identical configurations. A male-configured commode embodiment is as shown in FIGS. 1-6, a female-configured commode embodiment is as shown in FIG. 7, and a unisex-configured shower embodiment is as shown in FIG. 8. It may be seen that the opening in the male-configured embodiment of FIGS. 1-6 is generally oval in shape and central (and approximately 11″ long and tapers from approximately 7¼″ at the rear to approximately 2″ at the front), whereas the through opening in the female-configured embodiment of FIG. 7 is generally horseshoe-shaped (and approximately 17″ long and tapered from approximately 7¼″ at the rear to approximately 4″ at the front) and extends in an upwardly, outwardly inclined, e.g. stair-stepped configuration from a central region all the way to the front edge of the seat. This latter feature including a tapered opening near the top front edge facilitates wiping by a female user after urination, while preserving the overall circumferential contiguity and thus durability of the seat/cover.

FIG. 1 shows the invented seat/cover 10 in isometric view supported within the frame 12 of a conventional commode/shower chair 14. Those of skill in the art will appreciate that invented seat/cover 10 could be securely affixed in place above the conventional seat via two or more straps or ties. (The straps or ties could be integrally molded with the seat/cover so that they remain securely attached thereto.)

On the other hand, in order to simplify the seat/cover and to maintain the liquid impervious nature thereof, it has been discovered that seat/cover requires no attachment, since its own weight renders it as secure and stable as the chair on which it is mounted, without resort to straps or ties. Those of skill also will appreciate that the invented seat alternatively, but within the spirit of the invention, can be mounted in place of the normal seat on peripheral support members provided in a specially configured commode/shower chair of custom design to accommodate the invented seat/cover. But within the spirit and scope of the invention, a large installed base of stock commode/shower chairs can be retrofitted without modification thereto by the invented seat/cover to achieve the many advantages of the invention.

FIG. 1 perhaps best illustrates two important features of invented seat/cover 10.

First, a lumbar support 20 is provided for added comfort and lower-back support, distinguishing the invention over conventional seats and covers that lack any such support. It is noted that geriatric users and user with back problems, as well as disabled persons in general, greatly benefit from lumbar support, as an unfortunately increasing amount of time is spent by such users on their shower/commode chairs due to lack of mobility and often progressive gastrointestinal and bladder or bowel voiding, i.e. elimination, difficulties.

Second, better lateral support, stability and security are provided by the contoured seat/cover made in accordance with the invention by which the user's buttocks and thighs are not only load-bearing weight supportive but also weight-distributed across a larger support surface area. This is achieved in accordance with the invention by shaping the upper generally planar surface 22 of the seat/cover 10 to conform with a user's body, i.e. the user's buttocks and, especially, thighs. Thus, laterally spaced (and slightly tapered, rear-to-front) thigh recesses 24, 26 are provided that extend generally in parallel from the front edge of the opening 28 (and slightly radially from the rear edge of the cover/seat) to the front edge 30 of the seat/cover 10, as shown. This important feature of the invention relieves pressure from the femurs and pelvis and knee joints and is found to be much more comfortable, especially during a relatively long sit.

In accordance with a preferred embodiment of the invention to be described in more detail below, the invented seat/cover is made of a molded, so-called “memory” foam material that is elastic or memory-retentive, but temporarily deformable. This advent renders the seat/cover far more comfortable and supportive than are conventional seats, since it slightly yields to the user's body while securely and firmly supporting the user's body. Such molded foam material heretofore is believed to have been used only in high-end mattresses and pillows, applications in which comfort trumps stability and support in terms of importance and applications in which strong steel frames or other metal structures, e.g. inner-spring mattresses or boards, underlie the mattresses and pillows and are required to support a sleeper's weight.

Thus, it is surprising that such a material can be structured into a seat/cover having a necessary central opening (for elimination), but also having sufficient structural integrity around its periphery to afford sufficient load-bearing capacity securely to support a human being's weight. Moreover, the molded foam provides unprecedented comfort and stability, since it effectively ‘molds’ or conforms somewhat to (thereby frictionally engaging over a larger surface area) the user's body and thus increases the fact and sense of safety and security by the user.

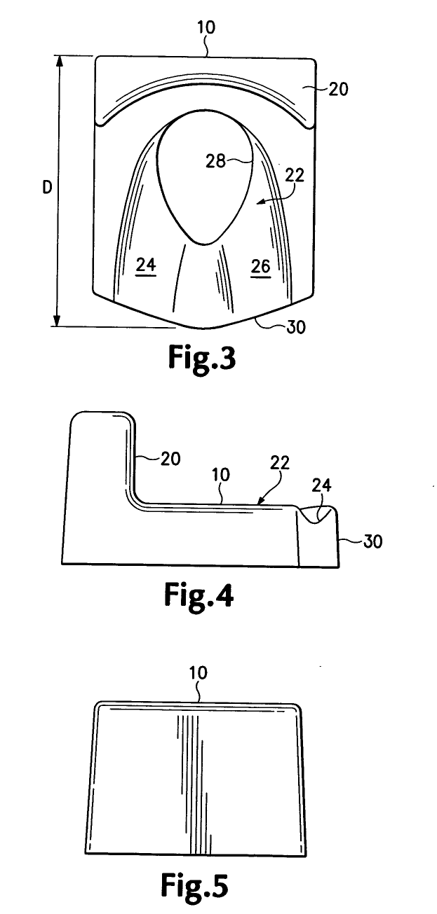

It may be seen that the invented seat/cover 10 is approximately 10-12″ (e.g. 10⅝″) high and approximately 15-16½″ (e.g. 15¾″) wide overall, as indicated in FIGS. 2 and 3 at H and W, respectively. It may also be seen from FIG. 2 that the thickness or height T of the horizontally extending region of the seat is approximately 4-5″ (e.g. 4⅝″), with the two symmetrically located thigh recesses or channels 24, 26 being approximately 1-1.5″ deep. The thickness or height T of the seat's horizontally extending region relative to the width W of the same are in a ratio then of approximately 1 to 4, which represents a relatively high vertical aspect ratio that is unconventional when contrasted with prior art commode seats in which such ratio typically is more than approximately 1 to 16. This additional height of the upper seating surface of seat/cover 10 elevates the support for the user's body when seated above the floor, thereby rendering it easier for a relatively immobile or inflexible user to get on and off the commode. It also renders it possible to dramatically change the configuration of the upper surface of the seat better to accommodate users of all capabilities, as will be explained immediately below.

The radically unconventional thigh-conforming recesses 24, 26—which are approximately 1½ to 2½″ (e.g. approximately 1¾″) deep near their centerlines—will be understood to provide for far superior weight distribution across the seat/cover than is possible with conventional, relatively flat cushioned expanses. It will also be appreciated that the thigh-conforming recesses 24, 26 tend to provide the user with increased lateral stability when the user is seated and when the user is moving or being moved into or out of the commode/shower chair. It will be understood from FIG. 2 that the body-conforming lumbar support member 20 extends above the upper seat/cover surface 22 by approximately 8-11″ (e.g. 10½″), thereby providing excellent lower-back support for the user.

Those of skill in the art will appreciate that lumbar support member 20 is convexly bowed or curved, in accordance with one embodiment of the invention, (e.g. by approximately 2¾″) to conform to and better to support the user's anatomically curved lower back. (See FIG. 3, from which it can be seen that the radius of curvature of the lumbar support is approximately 12-18″, e.g. 15″.)

It is believed to be the combination of the density and composition of the molded foam and the height-to-width ratio of the seat that provides the needed structural integrity discussed above. Nevertheless, those of skill in the art will appreciate that these dimensions can vary within the spirit and scope of the invention, for structural, fit, comfort or other suitable accommodations. Indeed, the invented seat/cover 10 can be provided in various sizes such as small, medium and large to accommodate users of widely varying and/or variable body styles.

(Those of skill in the art will appreciate that the dimensions described and illustrated herein represent a medium/standard size configuration that conforms with the needs of users having medium builds and body sizes and styles. Thus, various sizes of commode and/or shower seats and/or covers are contemplated as being within the spirit and scope of the invention.)

From FIG. 3 it may be seen that the invented seat is approximately 21″ deep along a central axis, as indicated at D. This dimension also may vary, within the spirit and scope of the invention, to accommodate users having shorter legs or users who are more sensitive to arterial pressure on the underside of their thighs. This is because the seat/cover 20 can rest on a relatively high, standard or stock chair, in which case a shorter user's feet might not touch the floor. If it is desired to have the elevation of the upper surface 22 of the seat/cover 10 closer to the floor, the seat/cover can be installed in a custom chair providing a lower peripheral support effective to lower this upper elevation of the seating support surface.

From FIG. 3 it also may be seen that the front edge 30 of the invented seat/cover 10 also is convexly rounded or curved in accordance with one embodiment of the invention so that it is deeper along the central axis than it is along either lateral edge. (See FIG. 3, from which it can be seen that the radius of curvature of the front edge also is approximately 12-18″, e.g. 15″.) This front-edge curvature is believed greatly to facilitate getting on and off the seat/cover 10, and represents yet another beneficial structural difference over conventional seats.

FIG. 4, a left-side elevation, shows the contoured lumbar support 20 in lateral view, detailing this important feature of the invention that provides unprecedented lower-back or lumbar support to a user of the invention. The fact that there is no known commode/shower chair that provides lumbar support for a user represents a lack of understanding of the needs of users who, increasingly, unfortunately, have missing limbs, mobility problems, back problems and/or elimination problems that render a commode or shower ‘session’ long, difficult and even painful.

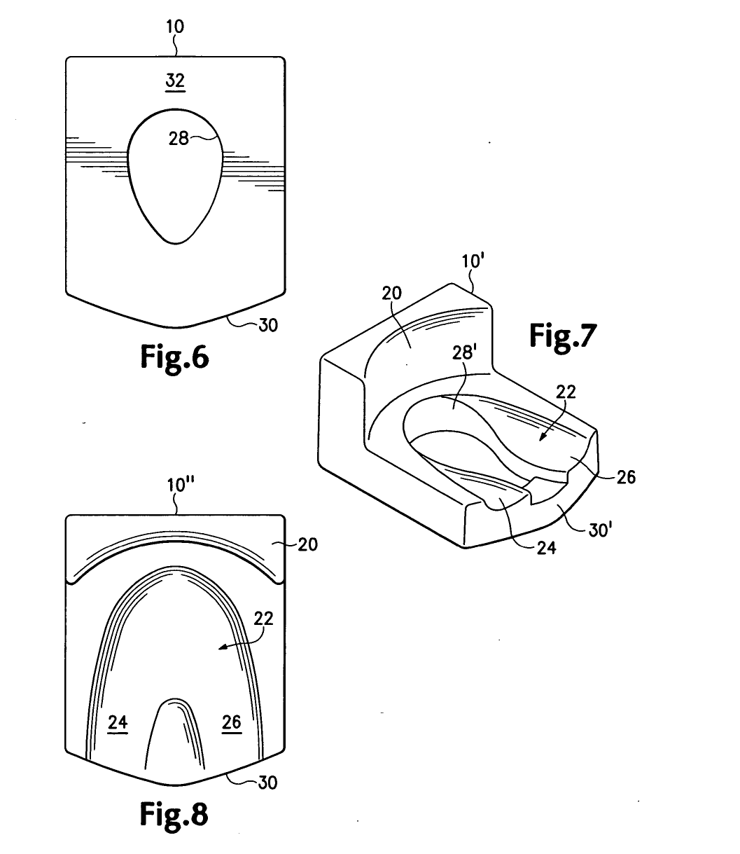

FIGS. 5 and 6 show seat/cover 10 respectively in a rear elevation and a bottom view, in the interest of comprehensive disclosure of the invention. Those of skill in the art will appreciate from FIG. 6 that the bottom surface 32 of seat/cover 10 in accordance with one embodiment of the invention is generally smooth and planar (but is configured not to skid), and is interrupted only by the opening 28.

FIG. 7 shows the invented seat/cover in an alternative embodiment to that of FIG. 1. The important difference is clear: in this embodiment, the opening 28′ in the seat is somewhat more teardrop or horse-shoe shaped than oval and the narrow end of the horse-shoe opening extends to the front edge 30′ of the seat/cover 10′ in this alternative embodiment of the invention. This slight shape difference for the opening better accommodates female users who typically perform a frontal wipe after urination. Thus the teardrop-shaped opening makes extra room for the female user's hand comfortably to pass partway into the horse-shoe shaped, downwardly, inwardly stepped or otherwise tapered opening 28′. Those of skill in the art will appreciate that horse-shoe shaped opening 28′, within the spirit and scope of the invention, have an alternative shape or alternative dimension or forward extent that nevertheless accommodates female users. For example, opening 28′ perhaps need not reach all the way to front edge 30′ of the seat/cover 10′ but still might effectively provide access for wiping so long as it tapers downwardly and inwardly from the front edge of the seat/cover toward the through part of the opening.

FIG. 8 illustrates an embodiment of the invention in which there is no opening provided in the seat/cover 10″. This embodiment is particularly useful in hospital, assisted living or hospice settings in which the user is wheeled into a shower setting not for the purpose of elimination but instead for the purpose of showering while seated comfortably for an extended period of time. The modified shower seat/cover 10″ can be otherwise similar or identical to commode seat/cover 10, so that the user enjoys all the advantages of stability, security, back support and comfort that are provided by the uniquely configured and shape-retentive but yieldable memory foam and unitary molded construction. The invented shower seat/cover 10″ nevertheless fits the typically wheeled shower chairs that already are in widespread use, and thus promotes easy and cost-effective retrofitting thereof for full enjoyment of the inventions' many advantages. Those of skill in the art will appreciate that shower seat/cover 10″ is of a unisex configuration, since there is no need for a through opening or female wiping after elimination by the unisex user.

Those of skill also will appreciate that no ties are needed in other embodiments of the invention, as the weight of the shower/commode seat/covers 10, 10′ and 10″ (e.g. approximately 5-7 pounds, e.g. 6½ pounds, in accordance with one embodiment of the invention), their non-skid bottom surfaces 32, and their load-bearing and lateral support by the frame F of the seat or chair are adequate to stabilize and secure them. Accordingly, from any of FIGS. 1-8, it may be seen that seat/covers 10, 10′ and 10″ securely fit within a suitable region interior of frame F of the commode/shower chair.

Those of skill in the art will appreciate that the bottom surface of the invented seat/cover 10, 10′ and 10″ in accordance with one embodiment of the invention identically include a non-skid but smooth and planar bottom surface 32 (see FIG. 6) of a size and configuration that is compatible with existing seats and chair frames.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

From the foregoing, those of skill in the art will appreciate that several advantages of the present invention include the following.

The present invention provides unprecedented fit, comfort, security and hygiene in a portable commode/shower chair seat/cover. Its molded, body-conforming but body-supporting structure provides superior safety and security for the user than do convention commode/shower chairs. Moreover, its gently thigh-hugging and lower-back-hugging contours render use of a retrofitted or specially-equipped commode/shower chair a far more pleasant experience, especially by users having limited mobility. It is retrofit-able to the huge and growing installed base of conventional commode/shower chairs, or it can be incorporated into a custom-made chair specially dimensioned and structured to accommodate it at any desired height above the floor. Its preferred construction nevertheless is a relatively inexpensive one-piece casting of medium-to-high-density “memory” foam that preferably is rendered hygienic by a special one-step application of a coating or surrounding envelope of anti-microbial, breathable but waterproof material.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

Accordingly, while the present invention has been shown and described with reference to the foregoing embodiments of the invented apparatus, it will be apparent to those skilled in the art that other changes in form and detail may be made therein without departing from the spirit and scope of the invention as defined in any appended claims.

I claim:

1. A seat for use with a shower chair, the seat comprising:
a seat region including a contoured upper surface for supporting a user's buttocks and thighs, the upper surface including dual laterally spaced recesses in the upper surface to accommodate the user's thighs; and
a lumbar support region behind the seat region for supporting the user's lower back.

2. The seat of claim 1, wherein the seat region and the lumbar support region are integrally molded together into a unitary seat.

3. The seat of claim 2, wherein the unitary seat is formed by injection or blow molding.

4. The seat of claim 3, wherein the unitary seat is formed of foam having defined temporary deflection and indefinite shape retention characteristics.

5. The seat of claim 4, wherein at least a front surface of the lumbar support region and at least the upper surface of the seat region are substantially covered with a substantially impervious material that is non-reactive with the user's skin.

6. A commode seat for use with a chair having a removable pan therein, the seat comprising:
a seat region including a central opening for alignment with the pan, the seat region further including a contoured upper surface for supporting a user's buttocks and thighs, the upper surface including dual laterally spaced recesses in the upper surface to accommodate the user's thighs; and
a lumbar support region behind the seat region for supporting the user's lower back.

7. The seat of claim 6, wherein the seat region and the lumbar support region are integrally molded together into a unitary seat.

8. The seat of claim 7, wherein the unitary seat is formed by injection or blow molding.

9. The seat of claim 8, wherein the unitary seat is formed of foam having defined temporary deflection and indefinite shape retention characteristics.

10. The seat of claim 9, wherein at least a front surface of the lumbar support region and at least the upper surface of the seat region are substantially covered with a substantially impervious material that is non-reactive with the user's skin.

11. The seat of claim 10, wherein the opening is generally oval in shape and extends only partway toward a front edge of the seat region.

12. The seat of claim 10, wherein the opening is generally teardrop in shape or horse-shoe shaped with an outer reach of the opening extending fully to a front edge of the seat region.

13. The seat of claim 10, wherein a bottom surface of the seat region is generally planar and configured not to slip relative to a supporting frame portion of the chair.

14. The seat of claim 15, wherein the dual recesses are generally parallel with one another and are generally cylindrical in shape and extend to a front edge of the seat region.

15. A commode comprising:
a frame configured to support a seated user thereon, the frame including a seat having a first opening therein and a waste receptacle under and aligned with the first opening:
a cover above the seat, the cover comprising:
a smoothly molded generally horizontally oriented forward expanse having an upper surface configured to conformingly engage a seated user's buttocks and thighs,
a second opening in the forward expanse generally aligned with the first opening,
a smoothly molded generally vertically oriented rear expanse having a forward surface configured to engage a lumbar region of the user's lower back,
the cover being unitarily formed of a foam material having defined temporary deflection and indefinite shape retention characteristics.

16. The commode of claim 15, wherein the upper surface of the forward expanse includes dual laterally spaced recesses in the upper surface, the recesses extending generally in parallel with one another at least from a central region of the forward expanse adjacent the opening to a front edge of the forward expanse, the recesses being configured to cradle undersides of the user's thighs.

17. The commode of claim 16, wherein the frame includes armrests.

18. The commode of claim 17, wherein the frame includes wheels.

19. The commode of claim 18, wherein a front edge of the forward expanse is convexly curved such that the cover is deeper near the middle than at either side thereof.

20. The commode of claim 19, wherein a bottom surface of the seat region is generally planar and configured not to slip relative to a supporting frame portion of the chair.

21. The commode of claim 20, wherein at least the upper surface of the forward expanse is substantially liquid-impervious.

22. The commode of claim 21, wherein at least the forward surface of the rear expanse and at least the upper surface of the forward expanse are non-reactive with the user's skin.
